(19) United States
(12) Patent Application Publication
(10) Pub. No.: US 2014/0038008 A1
(43) Pub. Date: Feb. 6, 2014

(54) BATTERY MODULE

(71) Applicants: Kouichi Saitou, Gifu (JP); Ryosuke Usui, Aichi (JP); Yoh Takano, Osaka (JP)

(72) Inventors: Kouichi Saitou, Gifu (JP); Ryosuke Usui, Aichi (JP); Yoh Takano, Osaka (JP)

(73) Assignee: SANYO ELECTRIC CO., LTD., Moriguchi-shi, Osaka (JP)

(21) Appl. No.: 13/983,050

(22) PCT Filed: Jan. 11, 2012
(86) PCT No.: PCT/JP2012/000126

§ 371 Date: Oct. 15, 2013

(30) Foreign Application Priority Data
Jan. 31, 2011 (JP) 2011-019082

(51) Int. Cl. H01M 10/50

(52) U.S. Cl. CPC H01M 10/50
USPC 429/62; 429/120; 429/72

(57) ABSTRACT

A battery cell module includes a plurality of battery cells arranged to each other, bus bars used to connect external terminals of the plurality of battery cells, and separators provided between adjacent battery cells. Each battery cell includes an electrode body, a casing that houses the electrode body, and external terminals, provided external to the casing, which are electrically connected to the electrode body. The separator includes a heat transfer section that performs heat transfer between the heat section and the battery cell and an insulator that electrically insulates between the heat transfer section and the battery cell. The heat transfer section has a thermal conductivity higher than that of the insulator.

### CROSS-REFERENCE TO RELATED APPLICATIONS

This application is the U.S. National Phase under 35U.S.C. §371 of International Application No. PCT/JP2012/000126, filed on Jan. 11, 2012, which in turn claims the benefit of Japanese Application No. 2011-019082, filed on Jan. 31, 2011, the disclosures of which Applications are incorporated by reference herein.

### BACKGROUND OF THE INVENTION

1. Field of the Invention

The present invention relates to a battery cell module where a plurality of battery cells are connected in series.

2. Description of the Related Art

The electromotive force of a battery cell (a single cell) is generally low. Even for a lithium-ion cell that is said to have a high electromotive force, its electromotive force is about 4 V. Accordingly, where a higher voltage is required, modularization is employed whereby a plurality of cells are connected in series with each other. In such a case where a plurality of battery cells are modularized, a plate-like metallic component is used to connect electrodes between each cell.

The battery cell may produce heat while it is being charged or discharged. Thus, particularly when a plurality of battery cells are combined into a single module, the amount of heat produced by the module increases and this increased amount of heat is liable to raise the internal temperature of the battery cells. The increase in the internal temperature thereof degrades the battery performance, thereby contributing to reduction in the battery life.

In the light of this, proposed is an electrically-conductive terminal connecting member that connects the electrode terminals between a plurality of single battery cells. This terminal connecting member includes a pair of contact parts in contact with each electrode terminal and an element body with which to connect between said pair of contact parts, wherein a heat-radiating unit is placed in at least part of the element body (see Patent Document 1). The aforementioned heat-radiating unit in the terminal connecting member inhibits the rise in temperature occurring between the electrode terminal and the terminal connecting member while the battery cell is being charged or discharged. Thus, it is assumed that the increase in contact resistance can be suitably suppressed.

### RELATED ART DOCUMENTS

### Patent Documents

[Patent Document 1] Japanese Unexamined Patent Publication No. 2010-212155.

### SUMMARY OF THE INVENTION

Nevertheless, the aforementioned terminal connecting member is configured such that the element body is bellows-shaped and therefore a conduction path between the electrode terminals is long. Accordingly, the resistance between the electrode terminals gets larger and thereby the amount of heat produced increases. Also, the heat radiation in areas other than the connecting member is not taken into consideration.

The present invention has been made in view of these problems, and a purpose thereof is to provide a technology capable of suppressing the performance degradation of a battery cell module.

In order to resolve the foregoing problems, a battery cell module according to one embodiment of the present invention includes: a plurality of battery cells, arranged to each other, each battery cell having an electrode body, a casing that houses the electrode body, and external terminals, provided external to the casing, which are electrically connected to the electrode body; a connecting member configured to connect the external terminals of the plurality of battery cells; and a temperature adjustment unit provided between adjacent battery cells. The temperature adjustment unit includes: a heat transfer section that performs heat transfer between the heat transfer section and the battery cell; and an insulator that insulates between the heat transfer section and the battery cell. The heat transfer section has a thermal conductivity higher than that of the insulator.

By employing this embodiment, the heat transfer is performed between the battery cells and the heat transfer section. Thus, for example, conducting the heat generated by the battery cells to the heat transfer section can suppress the rise in temperature of the battery cells.

The heat transfer section, which flows through a first flow passage formed in the insulator, may be a heat medium that performs heat transfer with exterior.

The battery cell module may further include a circuit board having a substrate and a wiring layer provided on the substrate. The circuit board may have a second flow passage through which the heat medium performs heat transfer with exterior.

The second flow passage may communicate with the first flow passage.

The battery cell module may further include: a temperature detector configured to detect the temperature of the battery cell module; and a control system configured to control the temperature of the heat medium according to the temperature detected by the temperature detector.

The heat transfer section may be a solid material. The solid material may, for example, be a metallic material such as a material having a high thermal conductivity.

The heat transfer section may be thermally integrated with the connecting member.

The battery cell module may further include: a temperature detector configured to detect the temperature of the battery cell module; and a device configured to cool or heat the heat transfer section according to the temperature detected by the temperature detector

The insulator may be constructed of at least one material selected from the group consisting of an insulating resin, an oxide, and a nitride.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic diagram showing a rough structure of a battery cell system according to a first embodiment;

FIG. 2 is a cross-sectional view showing a rough structure of a battery cell;

FIG. 3 is a transparent perspective view showing an example of the separator shown in FIG. 1;

FIG. 4 is a side view showing essential parts of a battery cell module of FIG. 1;

FIG. 5 is a top view showing essential parts of a battery cell module of FIG. 1;

FIG. 6 is a side view of a battery cell module according to a second embodiment;

FIG. 7 is a side view of a battery cell module according to a third embodiment;

FIG. 8 is a side view of a battery cell module according to a fourth embodiment;

FIG. 9 is a top view near a bus bar in a battery cell module according to a fourth embodiment;

FIG. 10 is a side view of a battery cell module according to a fifth embodiment; and

FIG. 11 is a side view of a battery cell module according to a sixth embodiment;

FIG. 12 is an exemplary flowchart of controlling the temperature in a battery cell system; and

FIGS. 13A and 13B are perspective views each showing a rough structure of a metallic surface fastener according to a first embodiment.

### DETAILED DESCRIPTION OF THE INVENTION

Hereinafter, the present invention will be described based on preferred embodiments with reference to the drawings. The same or equivalent constituents will be denoted with the same reference numerals in the description of each drawing, and the repeated description thereof will be omitted as appropriate.

### First Embodiment

[Battery Cell System]

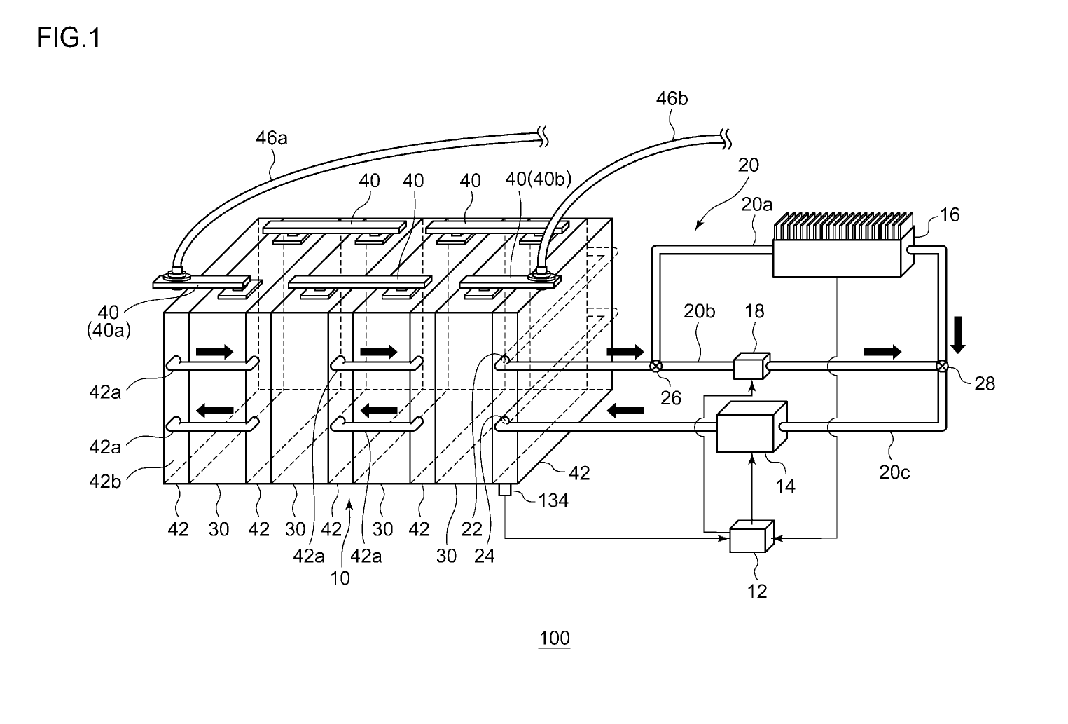

FIG. 1 is a schematic diagram showing a rough structure of a battery cell system according to a first embodiment. The battery cell system 100 includes a battery cell module 10, a temperature monitor 12 for controlling the operation of each device based on the detected temperature of the battery cell module 10, a circulation pump 14 for circulating the water, which serves as a heat medium, in a piping installed in the battery cell module 10, a heat exchanger 16 for cooling the water that serves as the heat medium, a heater 18 for heating the water that serves as the heat medium, and a piping system 20 for circulating the water.

The piping system 20 is connected to an outlet 22, through which the water is discharged from the battery cell module 10, and a delivery port 24, through which the water is delivered to the battery cell module 10. Also, the piping system 20 is configured by a first piping 20a midway on which the heat exchanger 16 is provided, a second piping 20b on which the heater 18 is provided, and a third piping 20c on which the circulation pump 14 is provided. The both ends of the first piping 20a and the both ends of the second piping 20b are connected through a three-way valve 26 and a three-way valve 28. The third piping 20c couples the three-way valve 28 with the delivery port 24

The openings and closings of the three-way valve 26 and the three-way valve 28 are controlled by instruction signals from the temperature monitor 12. The water discharged from the outlet 22 circulates within the battery cell system 100 by way of either the first piping 20a or the second piping 20b by the action of the circulation pump 14.

[Battery Cell Module]

The battery cell module 10 includes a plurality of battery cells (single cells) 30, which are disposed slightly apart from each other, bus bars (terminal connecting members) 40 that electrically connect external terminals (i.e., positive electrode terminals and negative electrode terminals) of the plurality of battery cells, and separators 42, which function as temperature adjustment units, provided between adjacent battery cells 30 as well as at both ends of the battery cell module 10.

[Battery Cells]

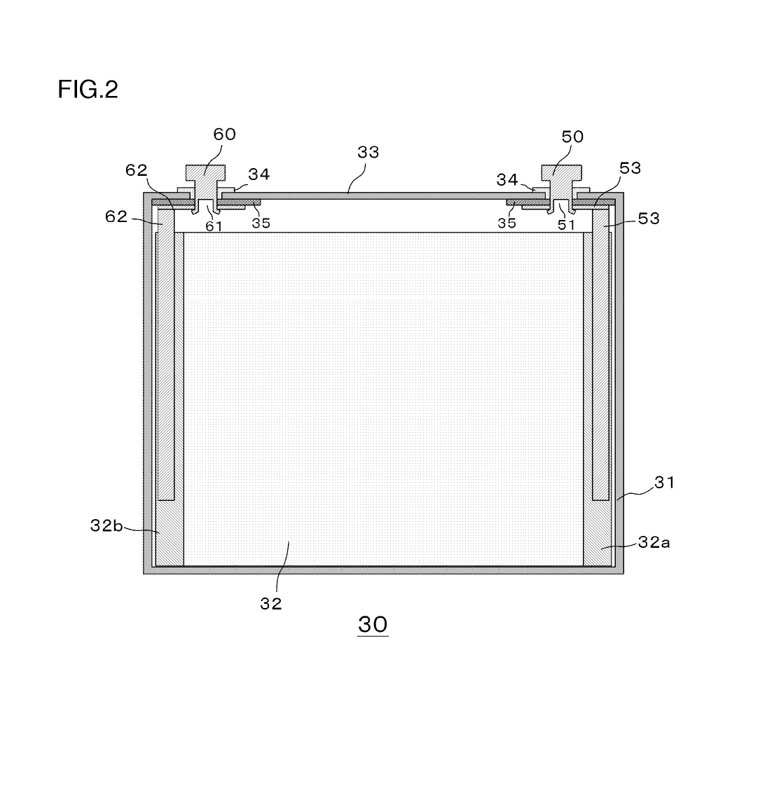

FIG. 2 is a cross-sectional view showing a rough structure of a battery cell 30. As illustrated in FIG. 2, the battery cell 30 is configured such that an electrode body 32, whose positive and negative electrodes are wound in a spiral shape, is housed, in an outer package can (enclosure or casing) 31, laterally relative to a direction of a can axis of the outer package can 31 and such that the opening of the outer package can 31 is sealed by a sealing plate 33. A positive electrode terminal 50 and a negative electrode terminal 60, which both protrude outwardly from the battery cell 30, are provided in the sealing plate 33. Also, a gas exhaust valve (not shown) is formed in the sealing plate 33.

The positive electrode terminal 50 is fitted into an opening, provided for a positive electrode, in the sealing plate 33 while the positive electrode terminal 50 is in contact with a gasket 34. Also, the positive electrode terminal 50 connects to a positive electrode tab member 53 on the inside of the battery cell underneath the sealing plate 33. A recess 51 is formed in an end part of the positive electrode terminal 50 fitted into the opening, provided for the positive electrode, in the sealing plate 33. And the recess 51 is formed such that a side wall is formed along the opening, provided for the positive electrode, in the sealing plate 33. The positive electrode terminal 50 is secured in a manner such that a rim part of the positive electrode terminal 50 enclosing the recess 51 is widened outwardly. A core part of the positive electrode terminal 50 (not shown) is formed of aluminum, and the core part thereof is covered with a copper plating layer (not shown). An insulating plate 35 is provided between the positive electrode tab member 53 and an underside of the sealing plate 33 on the inside of the battery cell. The insulating plate 35 and the gasket 34 abut against each other in the opening, provided for the positive electrode, in the sealing plate 33. This structure insulates the positive electrode tab member 53 and the positive electrode terminal 50 from the sealing plate 33.

The positive electrode tab member 53 connects to a positive electrode current collector group 32a that protrudes from one end surface of the electrode body 32. Note that the positive electrode current collector group 32a is a bundled package of positive electrode current collectors where a plurality of positive electrodes protruding from one end surface of the electrode body 32 are packaged into a bundle.

The negative electrode terminal 60 is fitted into an opening, provided for a negative electrode, in the sealing plate 33 while the negative electrode terminal 60 is in contact with a gasket 34. Also, the negative electrode terminal 60 connects to a negative electrode tab member 62 on the inside of the battery cell underneath the sealing plate 33. A recess 61 is formed in an end part of the negative electrode terminal 60 fitted into the opening, provided for the negative electrode, in the sealing plate 33. And the recess 61 is formed such that a side wall is formed along the opening, provided for the negative electrode, in the sealing plate 33. The negative electrode terminal 60 is secured in a manner such that a rim part of the negative electrode terminal 60 enclosing the recess 61 is widened outwardly. The negative electrode terminal 60 is formed of copper in its entirety. An insulating plate 35 is provided between the negative electrode tab member 62 and an underside of the sealing plate 33 on the inside of the battery cell. The insulating plate 35 and the gasket 34 abut against each other in the opening, provided for the negative electrode, in the sealing plate 33. This structure insulates the negative electrode tab member 62 and the negative electrode terminal 60 from the sealing plate 33.

The negative electrode tab member 62 connects to a negative electrode current collector group 32b that protrudes from the other end surface of the electrode body 32. Note that the negative electrode current collector group 32b is a bundled package of negative electrode current collectors where a plurality of negative electrodes protruding from the other end surface of the electrode body 32 are packaged into a bundle.

As described above, the battery cell 30 according to the first embodiment has the positive electrode terminal 50 and the negative electrode terminal 60 as external terminals that electrically connect to the electrode body 32.

[Separator]

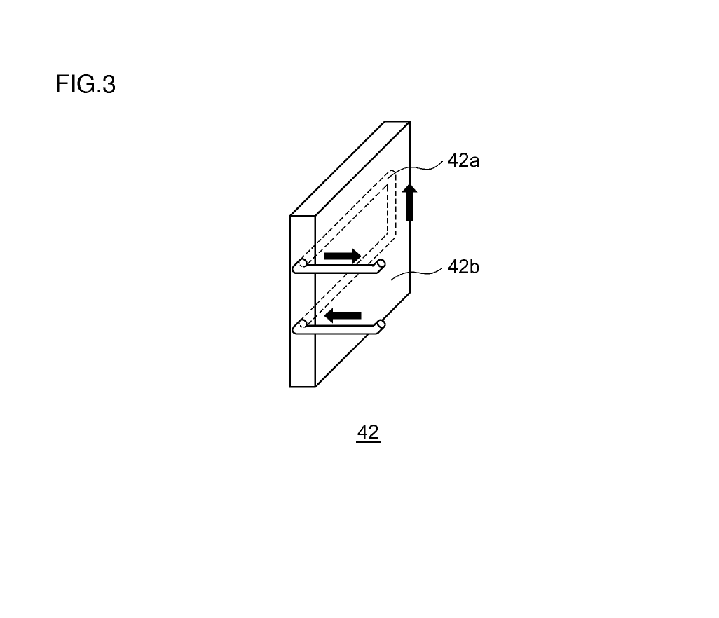

A description is now given of the separator 42 according to the first embodiment. FIG. 3 is a transparent perspective view showing an example of the separator 42 shown in FIG. 1. Of a plurality of separators provided in the battery cell module 10 of FIG. 1, the separator 42 shown in FIG. 3 is a leftmost separator 42 placed in a position farthest from the outlet 22.

The separator 42 includes a piping 42a, through which the heat medium (water) flows wherein the heat medium performs heat transfer between the heat medium and the battery cell 30, and an insulator 42b, which insulates the heat between the heat medium and the battery cell 30. The piping 42a functions as a first flow passage formed inside the insulator 42b. The heat medium, which functions as a heat transfer section, may be not only a liquid, such as water, but also a gas. Also, the heat medium has a thermal conductivity higher than that of the insulator 42b.

The battery cell module 10 according to the first embodiment performs heat transfer between the battery cells 30 and the heat medium that is the heat transfer section. Thus, for example, conducting the heat generated by the battery cell 30 to the heat medium can suppress the rise in temperature of the battery cell 30. As a result, the degradation of the battery performance caused by the rise in temperature thereof is restricted and therefore the life of the battery cell module as a whole can be extended.

In the battery cell module 10, the heat medium is discharged to the exterior of the battery cell module by way of the piping 42a and, at the same time, the heat medium that has been cooled by the heat exchanger 16 is again returned to the interior thereof. Thus, even though the amount of heat produced by the battery cells is large, the temperature of the battery cells can be adjusted by controlling the circulation of the heat medium by the circulation pump 14. In the battery cell module 10, the heat medium heated by the external heater 18 can also be circulated within the battery cell module. In such a case, the temperature of the battery cell 30 can be raised to a temperature suitable for charge and discharge, in a low-temperature environment. Thus the battery cell module 10 can easily radiate the heat to the exterior of the battery cell 30 and can easily heat the battery cell 30 with the heat from the exterior thereof.

The battery cell module 10 is configured such that the pipings 42a of their respective separators 42 are coupled together and such that the heat medium is circulated. Hence, the temperature of each battery cell 30 can be easily maintained uniformly. Accordingly, the difference in performance degradation among the respective battery cells 30 is made smaller and therefore the life of the battery cell module 10 as a whole can be extended.

[Terminal Connection Members (Bus Bars)]

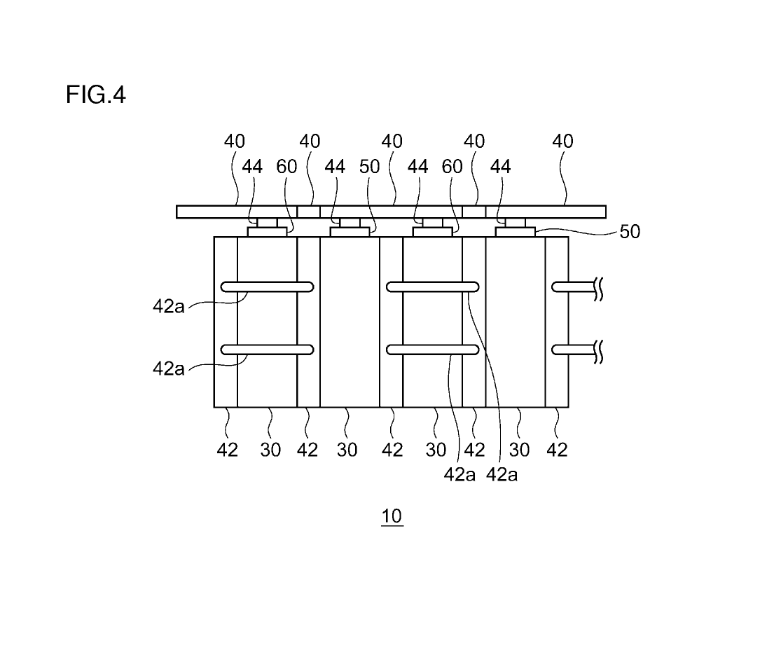

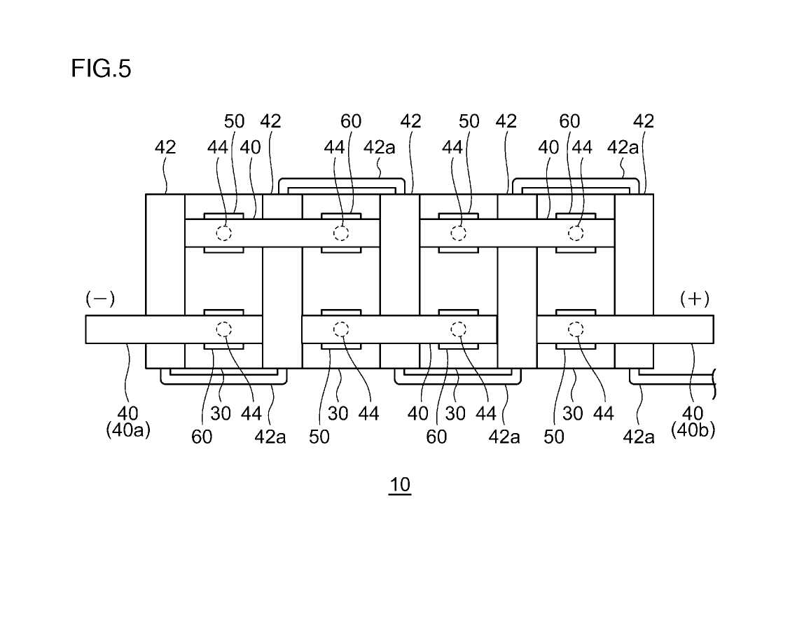

A description is now given of connection of each battery cell by use of bus bars. FIG. 4 is a side view showing essential parts of the battery cell module shown in FIG. 1. FIG. 5 is a top view showing essential parts of the battery cell module shown in FIG. 1. In the first embodiment, the total of four battery cells 30 are connected in series with each other so as to constitute the battery cell module 10. The number of battery cells 30 used is not limited to any particular number.

The four battery cells 30 are arranged side by side at predetermined intervals such that the battery cells 30 in a longer direction are placed approximately parallely, when viewed planarly. Tip parts of the positive electrode terminal 50 and the negative electrode terminal 60 in each battery cell 30 protrude from the top face of the casing of the battery cell 30. The positive electrode terminal 50 of one battery cell 30 and the negative electrode terminal 60 of the other battery cell 30 in the adjacent battery cells 30 are disposed opposite to each other. One negative electrode terminal 60 and the other positive electrode terminal 50 of two adjacent battery cells 30 are electrically connected to each other via a bus bar 40, so that the four battery cells 30 are connected in series with each other.

A method employed to connect the bus bar 40 with the positive electrode terminal 50 and the negative electrode terminal 60 may vary. Such a method includes a method for directly connecting them by use of solder, a method for joining them by diffusing a metal, a method for joining them by laser welding, and a method for indirectly joining them by way of other members such as screws or nuts, for instance. In the first embodiment, the bus bar 40 and each terminal are joined by use of a metallic surface fastener 44. The metallic surface fastener 44 can couple a plurality of members in a detachable manner such that a hook surface (or spike surface) on which steel hooks are formed are joined or affixed to a loop surface (or brush surface) on which steel loops are formed. In the first embodiment, the hook surface constituting the surface faster is secured to the positive electrode terminal 50 and the negative electrode terminal 60, and the loop surface is secured to the bus bar 40. And the hook surface and the loop surface are affixed together, so that the battery cells can be electrically connected to each other. Use of the surface fasteners 44 enables the attachment and detachment between the bus bars 40 and the battery cells 30, and enhances the workability of assembly, replacement and dismantlement of the battery cell module.

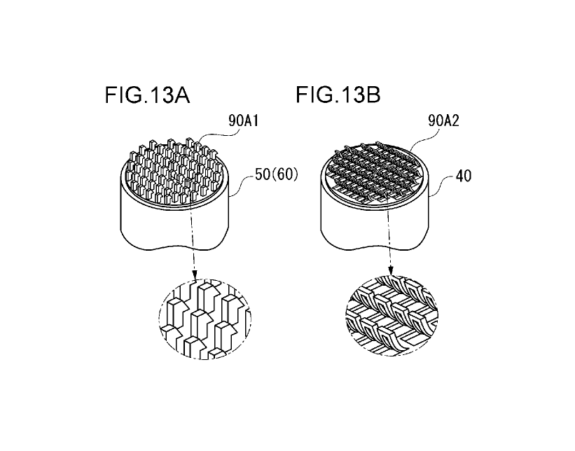

FIGS. 13A and 13B are perspective views each showing a rough structure of the metallic surface fastener according to the first embodiment.

As illustrated in FIGS. 13A and 13B, a hook-and-loop fastener may, for example, be used as a metallic surface fastener. This metallic fastener is comprised, for example, of a hook member 90A1, which is fixed onto the top face of the positive electrode terminal 50 (or the negative electrode terminal 60) by welding or the like, and a loop member 90A2, which is fixed onto the top face of the bus bar 40 by welding or the like. The hook member 90A1 has a plurality of hooks arranged in a matrix on the surface of the positive electrode terminal 50 (or the negative electrode terminal 60), and the loop member 90A2 has a plurality of loops arranged in a matrix thereof. When the top face of the positive electrode terminal 50 (or the negative electrode terminal 60) and the top face of the bus bar 40 are pressed together, the hooks of the hook member 90A1 are caught on the loops of the loop member 90A2. As a result, the positive electrode terminal 50 (or the negative electrode terminal 60) is connected to the bus bar 40 in a detachable manner.

As described above, in the battery cell module 10 according to the first embodiment, the metallic bus bar 40 and the metallic surface fastener 44 are used to connect each battery cell 30. Thus, as the temperature of the battery cells 30 rises excessively, a stress may work on a joint area of the metallic bus bar 40, the metallic surface fastener and each terminal and thereby may adversely affect the connection reliability. However, in the battery cell module 10 according to the first embodiment, the rise in temperature of the battery cells 30 is suppressed due to the provision and its action of the above-described separator 42. Thus, the occurrence of the stress in the joint area of the battery cell 30 and the bus bar 40 is inhibited and therefore the coupling reliability of each battery cell through the medium of the bus bars 40 improves.

Note that, of a plurality of bus bars 40 in the battery cell module 10, bus bars 40a and 40b on the both ends are fixed to wiring cables 46a and 46b at one ends shown in FIG. 1, respectively.

### Second Embodiment

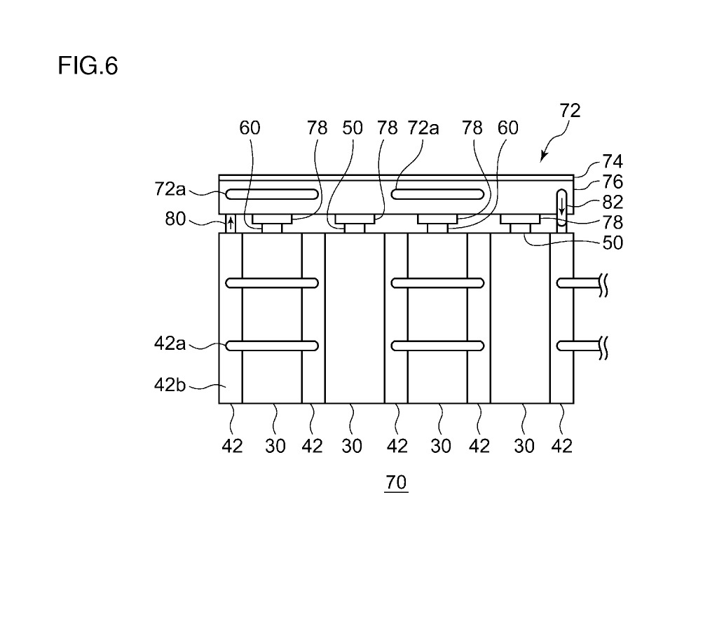

FIG. 6 is a side view of a battery cell module 70 according to a second embodiment. The battery cell module 70 as shown in FIG. 6 greatly differs from the battery cell module 10 according to the first embodiment in that a circuit board provided with a water-cooling piping is mounted on top of battery cells.

The circuit board 72 includes a metallic substrate 74, an insulating resin layer 76, and a wiring layer 78

The metallic substrate 74 is stacked on one main surface of the insulating resin layer 76. The metallic substrate 74 is a structural component where a metal, such as Al or Cu, which excels in thermal conductivity is processed into a flat plate and therefore the metallic substrate 74 improves the heat radiation of the circuit board 72.

The insulating resin layer 76 is a “substrate” of the circuit board 72. The material used to form the insulating resin layer 76 may be, for instance, a melamine derivative, such as BT resin, or a thermosetting resin, such as liquid-crystal polymer, epoxy resin, PPE resin, polyimide resin, fluorine resin, phenol resin or polyamide bismaleimide. From the viewpoint of improving the heat radiation of the circuit board 72, it is desirable that the insulating resin layer 76 has a high thermal conductivity. In this respect, it is preferable that the insulating resin layer 76 contains, as a high thermal conductive filler, silver, bismuth, copper, aluminum, magnesium, tin, zinc, or an alloy of any two or more of those.

The wiring layer 78 is formed such that a predetermined pattern is provided on the other main surface of the insulating resin layer 76. The wiring layer 78 according to the second embodiment is formed of copper.

Chip components (not shown) are mounted on one main surface of the circuit board 72. The chip components are comprised of semiconductor devices, such as ICs, and passive devices, such as resistors and capacitors. The chip components constitute a circuit section that monitors the voltage and temperature of the battery cells 30 and controls the connection status of the battery cells 30. More specifically, the circuit section monitors the voltage and temperature of each battery cell 30; if the voltage and/or temperature of a battery cell 30 indicates a malfunction, the connection of said battery cell 30 only or a plurality of battery cells including said battery cell 30 will be shut off.

The battery cells 30 are connected to the other main surface of the circuit board 72. More specifically, external terminals (i.e., positive electrode terminals 50 and negative electrode terminals 60) of the battery cells 30 are connected to the wiring layers 78 of the circuit board 72.

The circuit board 72 has a piping 72a as a second flow passage through which the heat medium, which performs heat transfer with the exterior, flows. The piping 72a is formed such that it meanders inside the circuit board 72. The heat medium (water), which flows through the piping 72a, carries the heat produced by each component of the circuit board 72 to the exterior. Thereby, the heat produced in the circuit board 72 can be radiated to the exterior. Also, delivering the heat medium heated at the exterior can heat the circuit board 72.

The piping 72a of the present embodiment communicates with a piping 42a of a separator 42. More to the point, the battery cell module 70 has a first interconnecting tube 80, through which the heat medium flows from any of a plurality of separators 42 toward the piping 72a of the circuit board 72, and a second interconnecting tube 82, through which the heat medium, which has passed through the piping 72a of the circuit board 72, flows toward any of the plurality of separators 42.

By employing the battery cell module 70 of the second embodiment instead of the battery cell module 10 of the battery cell system 100 according to the first embodiment, the heat produced in the circuit board 72 can be easily radiated to the exterior. Also, the circuit board 72 can be easily heated by the heat produced at the exterior. The temperature of the battery cell module 70 provided with the circuit board 72 can be adjusted particularly when the amount of heat produced in the circuit board 72 is large. Also, the piping 42a of the separator 42 communicates with the piping 72a of the circuit board 72. Thus, if the above-described temperature monitor 12, circulation pump 14, heat exchanger 16 and heater 18 are used, the temperatures of the battery cells 30 and the circuit board 72 can be simultaneously adjusted through the heat medium.

### Third Embodiment

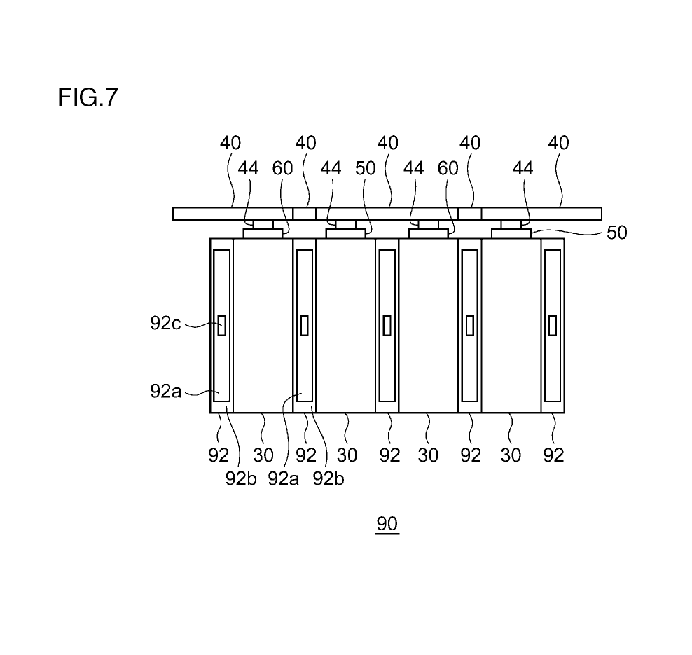

FIG. 7 is a side view of a battery cell module 90 according to a third embodiment. The battery cell module 90 as shown in FIG. 7 greatly differs from the battery cell module 10 according to the first embodiment in the structure of the separator that is a temperature adjustment unit. The other structural components are similar to those of the battery cell module 10.

Each separator 92 shown in FIG. 7 is a rectangular parallelopiped component that is similar to the separator 42 according to the first embodiment. The separator 92 includes a metallic member 92a, which is a solid material that performs heat transfer with the battery cell 30, and an insulator 92b, which insulates between the metallic member 92a and the battery cell 30. The insulator 92b may be formed of an insulating resin, an oxide, a nitride or the like. Hence, the insulation properties are ensured between the battery cell 30 and the metallic member 92a.

It is preferable that the metallic member 92a has a thermal conductivity higher than that of the insulator 92b. The metallic member 92a may be formed of a non-metal so long as its conductivity is higher.

In the battery cell module 90 according to the second embodiment, heat is transferred between the battery cell 30 and the metallic member 92a, which is a heat transfer section. The metallic member 92a is a rectangular parallelopiped which is slightly smaller than the separator 92. And two side surfaces of the metallic member 92a are exposed relative to the exterior. Thus the heat produced by the battery cell 30 is released from the side surfaces of the battery cell module 90 via the metallic member 92a. In other words, the heat produced by the battery cell 30 is radiated to the exterior via the metallic member 92a, so that the rise in temperature of the battery cell 30 can be suppressed. As a result, the degradation of the battery performance caused by the rise in temperature thereof is restricted and therefore the life of the battery cell module as a whole can be extended.

Also, the separator 92 has a cooling mechanism (cooling system) 92c for cooling the metallic members 92a. The cooling mechanism 92c may be a Peltier device, for instance. Provision of the cooling mechanism 92c can further inhibit the rise in temperature of the battery cell 30. A heating mechanism (heating system) may be provided in the separator 92 instead of or in addition to the cooling mechanism 92c. The heating mechanism may be an existing heater, for instance. Provision of the heating mechanism can raise the temperature of the battery cell 30 to a temperature suitable for charge and discharge, in a low-temperature environment.

Thus the battery cell module 90 can easily radiate the heat to the exterior of the battery cell 30 and can easily heat the battery cell 30 with the heat from the exterior thereof. It is to be noted here that a temperature sensor for detecting the temperature of the battery cell 30 may be installed in a predetermined position of the battery cell module 90. In this case, a not-shown control unit controls the cooling mechanism or heating mechanism based on the information on the temperature detected by the temperature sensor so as to cool or heat the metallic members 92a. Thereby, the battery cells 30 are indirectly cooled and heated through the metallic members 92a, so that the temperature of the battery cell module 90 can be adjusted within a certain range.

### Fourth Embodiment

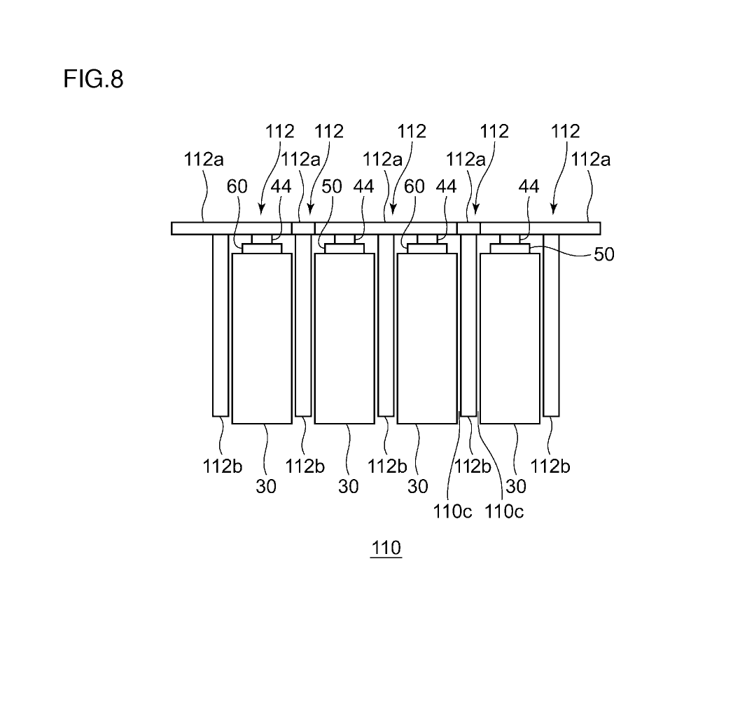

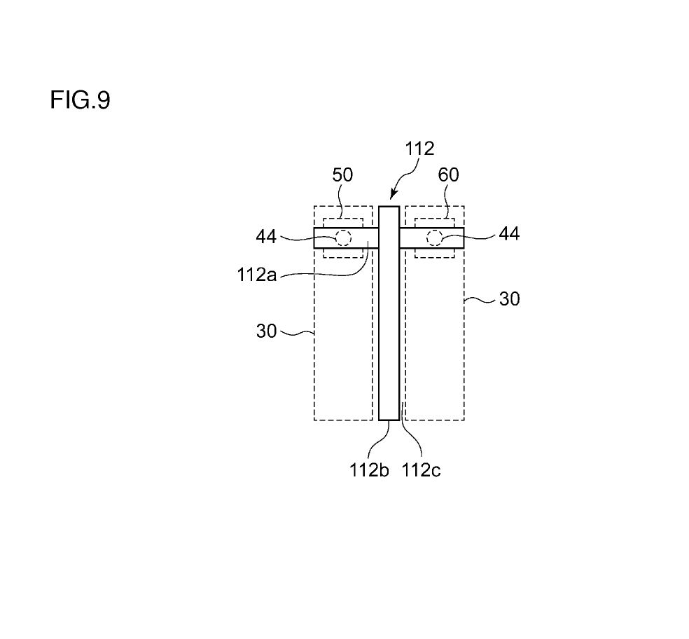

FIG. 8 is a side view of a battery cell module 110 according to a fourth embodiment. FIG. 9 is a top view near a bus bar in the battery cell module 110 according to the fourth embodiment.

A bus bar 112 is a component having a T-shaped appearance when viewed laterally from a side as in the side view of FIG. 8. The bus bar 112 is comprised of a plate-like rectangular connecting section 112a and a metallic rectangular-parallelopiped heat transfer section 112b. Here, in the connecting section 112a, one negative electrode terminal 60 and the other positive electrode terminal 50 of two adjacent battery cells 30 are connected to each other. The heat transfer section 112b extends along a spacing between the battery cells from the central part of the connecting section 112a downwardly. A temperature adjustment unit according to the fourth embodiment includes a heat transfer section 112b and an insulator 112c, which insulates between the heat transfer section 112b and the battery cell 30. The insulator 112c according to the fourth embodiment is a layer of air. As described earlier, the heat transfer section 112b is thermally integrated with the bus bar 112. Thus the transfer of heat between the battery cell 30 and the heat transfer section 112b can be accomplished through the bus bar 112.

### Fifth Embodiment

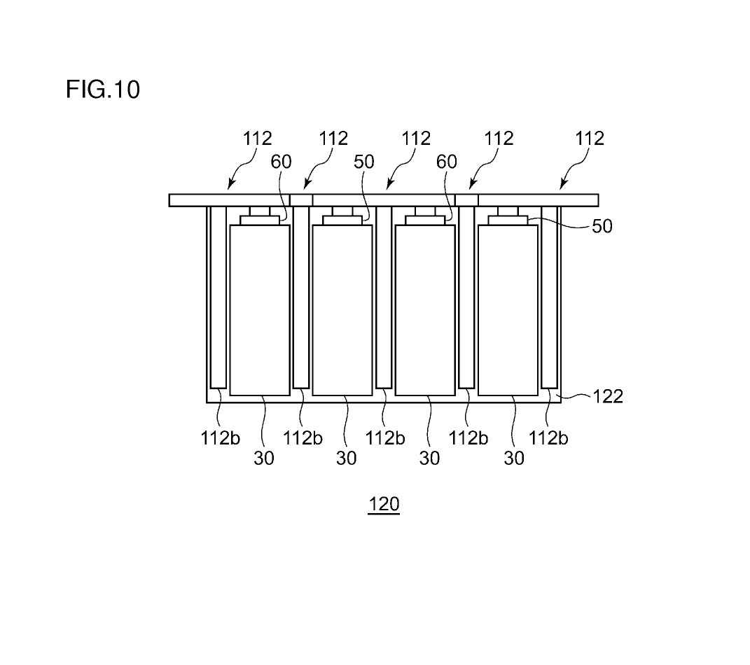

FIG. 10 is a side view of a battery cell module 120 according to a fifth embodiment. The battery cell module 120 as shown in FIG. 10 differs from the battery cell module 110 according to the fourth embodiment in that all of gaps surrounding the battery cells are sealed by an insulating resin 122. Thereby, the insulation reliability among the heat transfer sections 112b of the bus bars 112, the positive electrode terminals 50 and the negative electrode terminals 60 is enhanced.

### Sixth Embodiment

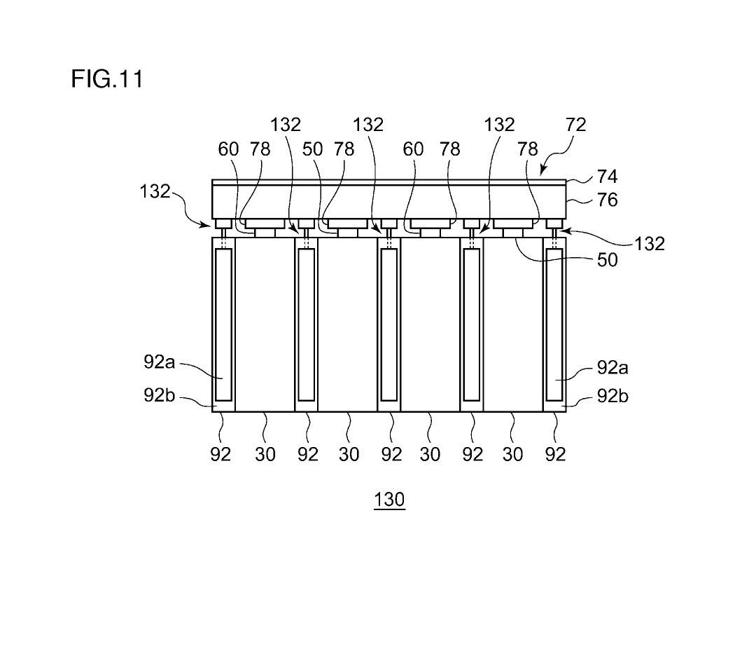

FIG. 11 is a side view of a battery cell module 130 according to a sixth embodiment. The battery cell module 130 as shown in FIG. 11 greatly differs from the battery cell module 90 according to the third embodiment in that a circuit board by which to connect adjacent battery cells is mounted on top of battery cells.

A plurality of cooling mechanisms (cooling systems) 132 are provided on a main surface of a circuit board 72 of FIG. 11 on a side thereof where wiring layers 78 are formed. The cooling mechanisms 132 are arranged on the surface of an insulating resin layer 76 such that the tips of the cooling mechanisms 132 come in contact with metallic members 92a of separators 92. The cooling mechanism 132 may be a Peltier device, for instance. Provision of the cooling mechanism 132 can further inhibit the rise in temperature of the battery cell 30. A heating mechanism (heating system) may be provided on top of an insulating resin layer 76 instead of or in addition to the cooling mechanism 132. Provision of the heating mechanism can raise the temperature of the battery cell 30 to a temperature suitable for charge and discharge, in a low-temperature environment. Thus the battery cell module 130 can easily radiate the heat to the exterior of the battery cell 30 and can easily heat the battery cell 30 with the heat from the exterior thereof.

[Control of Temperatures]

A description is now given of a method for controlling the temperature of the heat transfer section according to the temperature of the battery cell module. The description thereof will be given using the battery cell system 100 shown in FIG. 1 as an example.

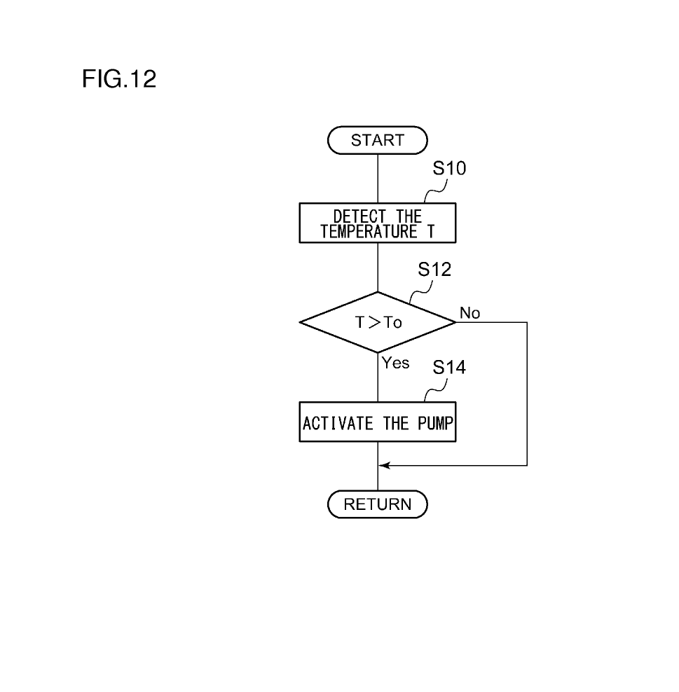

As described earlier, the battery cell system 100 has a piping system, provided external to the battery cell module 10, through which the heat medium is cooled or heated. Also, a temperature sensor 134 for detecting the temperature of the battery cell module 10 is mounted on the separator 42. FIG. 12 is an exemplary flowchart of controlling the temperature in the battery cell system 100.

As temperature T of the battery cell module 10 is detected by the temperature sensor 134 (S10), the temperature monitor 12 compares the detected temperature T against a predetermined threshold value T₀ (S12). If the detected temperature T does not exceed the predetermined threshold value (No of S12), the temperature monitor 12 will continue to acquire the temperature detected by the temperature sensor 134 without activating the circulation pump 14. If, on the other hand, the detected temperature T exceeds the predetermined threshold value (Yes of S12), the temperature monitor 12 will activate the circulation pump 14 (S14) and circulates water inside the separators 42 of the battery cell module 10. Since the heat in the circulating water is released by the heat exchanger 16 and thus the circulating water is constantly cooled, the battery cell module 10 is kept at a certain temperature or below.

If the battery cell 30 is to be heated in a low-temperature environment, the temperature monitor 12 will preferably control the openings and closings of the three-way valves 26 and 28 so that the water passes through the heater 18 and will preferably activate the circulation pump 14.

As described above, the battery cell system 100 includes the temperature monitor 12, the circulation pump 14, the heat exchanger 16, the heater 18, the temperature sensor 134 and so forth, all of which serve to function as a control mechanism (control system) for controlling the temperature of the heat medium in response to the temperature. These structural components serving as a control system can adjust the temperature of the battery cell module within a certain range.

By employing each of the above-described battery cell modules, the performance degradation of the battery cell module is suppressed and the reliability in the joint area of the electrodes and the bus bars, for example, is improved. Also, the heat transfer section, which constitutes a part of the heat radiating or adsorbing mechanism is provided between adjacent battery cells. Thus the height of the above-described battery cell modules is reduced as compared with a case where the similar structure is provided on the underside of the battery cells. Also, since the temperatures of the battery cell module and the circuit board can be controlled, the performance degradation of the battery cells due to the heat produced near the battery cells and the electrodes is suppressed. Also, since the stress caused by the heat produced near the electrodes is mitigated, the mechanical reliability in the joint area improves.

The present invention has been described by referring to each of the above-described embodiments. However, the present invention is not limited to the above-described embodiments only, and those resulting from any combination of them or substitution as appropriate are also within the scope of the present invention. Also, it is understood by those skilled in the art that various modifications such as changes in the order of combination or processings made as appropriate in each embodiment or changes in design may be added to the embodiments based on their knowledge and the embodiments added with such modifications are also within the scope of the present invention.

### INDUSTRIAL APPLICABILITY

The present invention is used for a battery cell module where a plurality of battery cells, such as lithium cells, are connected in series with each other.

1. A battery cell module, comprising:
a plurality of battery cells, arranged to each other, each battery cell having an electrode body, a casing that houses the electrode body, and external terminals, provided external to the casing, which are electrically connected to the electrode body;
a connecting member configured to connect the external terminals of the plurality of battery cells; and
a temperature adjustment unit provided between adjacent battery cells,
said temperature adjustment unit including:
a heat transfer section that performs heat transfer between the heat transfer section and the battery cell; and
an insulator that electrically insulates between the heat transfer section and the battery cell,
wherein the heat transfer section has a thermal conductivity higher than that of the insulator.

2. A battery cell module according to claim 1, wherein the heat transfer section, which flows through a first flow passage formed in the insulator, is a heat medium that performs heat transfer with exterior.

3. A battery cell module according to claim 2, further comprising a circuit board having a substrate and a wiring layer provided on the substrate,
wherein the circuit board has a second flow passage through which the heat medium performs heat transfer with exterior.

4. A battery cell module according to claim 3, wherein the second flow passage communicates with the first flow passage.

5. A battery cell module according to claim 2, further comprising:
a temperature detector configured to detect the temperature of the battery cell module; and
a control system configured to control the temperature of the heat medium according to the temperature detected by the temperature detector.

6. A battery cell module according to claim 1, wherein the heat transfer section is a solid material.

7. A battery cell module according to claim 6, wherein the heat transfer section is thermally integrated with the connecting member.

8. A battery cell module according to claim 6, further comprising:
a temperature detector configured to detect the temperature of the battery cell module; and
a device configured to cool or heat the heat transfer section according to the temperature detected by the temperature detector.

9. A battery cell module according to claim 1, wherein the insulator is constructed of at least one material selected from the group consisting of an insulating resin, an oxide, and a nitride.
